(19) United States
(12) Patent Application Publication
(10) Pub. No.: US 2007/0162596 A1
(43) Pub. Date: Jul. 12, 2007

(54) Server monitor program, server monitor device, and server monitor method

(75) Inventor: Atsuji Sekiguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/403,825

(22) Filed: Apr. 14, 2006

(30) Foreign Application Priority Data
Jan. 6, 2006 (JP) 2006-001007

(51) Int. Cl. G06F 15/173

(52) U.S. Cl. 709/224

(57) ABSTRACT

Disclosed is a medium, server monitor device, and server monitor method which are capable of obtaining an audit trail even if an administrator authority of a server leaks. The server monitor program is to be executed by a computer of an ATP 3 connected between a client machine 2 and a server machine 1. The server monitor program comprises: a relay step that relays between the client machine 2 and the server machine 1, and manages information concerning the relay by a relay information management table 32; and a server state monitor step that determines whether the server machine 1 works abnormally or not, based on communication between the ATP 3 and the server machine 1, and records, in a relay log 33, information included in relay information corresponding to relay to the server machine 1 and included in the relay information management table 32 if the server machine 1 is determined as working abnormally.

### BACKGROUND OF THE INVENTION

1. Field of the Invention

The present invention relates to a medium, server monitor device, and server monitor method to monitor abnormalities occurring in a server due to unauthorized access.

2. Description of the Related Art

Recently, people's attention has been paid to problems of enterprises losing confidence owing to leakages of personal information. According to the personal information protection law, it is required that information leakages from and unauthorized access to computers should be kept on record as audit trails (in computer forensics) to prove evidence for unauthorized traces. For a trail of system manipulation, information telling “when” “who” did “what” and ‘from which client’ is important, and prevention of alteration of recorded information is required.

Next, conventional techniques for obtaining audit trails will be described.

First conventional technology for obtaining audit trails is of a type which is introduced at an application level into a server and monitors the server. For example, there is a type that, registered users, registered applications, and registered groups of commands, which have been registered through intermediation from a client, are authorized. Also, there is another type that, registered groups of files are periodically monitored and compared with what these were at the time of registration, to detect alterations to files. Further, there is further another type in which real-time file monitoring is performed by monitoring file manipulation events.

Second conventional technology for obtaining audit trails is of a type which is introduced at a kernel level into a server and monitors the server. For example, the least necessary manipulation authorities are finely set, determined, and recorded for every process or every user. Even an administrator of the server cannot conduct alterations without specific authorities. There is need of response individually to each application.

Third conventional technology for obtaining audit trails is of a type in which a relay device installed between an external network and a server monitors access to the server. According to a technique disclosed in Jpn. Pat. Appln. Laid-Open Publication No. 2001-236278, a relaying fire wall determines authentication, access denial, or the like, to obviate leakage of information due to unauthorized access to respective calculators. According to another technique disclosed in Jpn. Pat. Appln. Laid-Open Publication No. 2003-186763, access to a terminal device is all made through a hack detection proxy server, and hack detection is achieved by checking logs of protocol violations, hack commands, and hack access results. According to yet another technique disclosed in Jpn. Pat. Appln. Laid-Open Publication No. 2005-156473, a relay connection device interconnects a client and a server. The relay connection device determines access denial, depending on communication procedures (protocols) or port numbers, and compiles logs from every server to make audit trails.

However, there is a case that an operator as an insider of a system takes out information or an unauthorized accessing person obtains system management account information (e.g., a password for root authority) by use of a security hole or the like. Thus, if administrator authority capable of obtaining trails leaks, there is a problem as follows.

First, if a regular protocol or service is used for hacking, hacking cannot be distinguished from regular access. Unauthorized access from a user having administrator authority cannot be prevented. For example, if a log or an unauthorized access monitor section is altered, the log or section cannot be approved as an trail. There is a case that no trail can remain by merely obtaining a log during a relay. For example, if a manipulation or result is encrypted, what manipulation has been made or what information has leaked cannot be specified although a log records that something has been operated.

In a large scale system (e.g., a system for financial business such as a bank system has a huge number of servers up to several hundred or several thousand), the conventional techniques for preventing unauthorized access and for obtaining trails at the kernel level involve problems below. That is, every change to the kernel is accompanied by restarting of the system, which may stop services. Changes to all the several hundred to several thousand servers require a huge number of processing steps (and costs).

### SUMMARY OF THE INVENTION

The present invention has been made to solve the problems described above, and has an object of providing a server monitor program, server monitor device, and server monitor method, which are capable of obtaining audit trails even when administrator authority of a server has leaked.

To achieve the above object, according to an aspect of the present invention, there is provided a computer-readable recording medium having a server monitor program recorded thereon, said program adapted to execute on a computer of a server monitor device connected between a client and a server, the program comprising: a relay step that relays between the client and the server, and manages information concerning the relay as relay information; and a server state monitor step that determines whether the server works abnormally or not, based on communication between the server monitor device and the server, and records, in a log, information included in relay information corresponding to relay to the server if the server is determined as working abnormally.

Preferably, in the medium according to the invention, if a server-normal notification as a notification given when the server works normally cannot be received, the server state monitor step determines the server as working abnormally.

Also preferably, in the medium according to the invention, the server-normal notification is transmitted to the server monitor device from the server at predetermined timing, and if the server monitor device cannot receive the server-normal notification for a predetermined period, the server state monitor step determines the server as working abnormally.

Also preferably, in the medium according to the invention, if a server-abnormal notification indicating that the server is working abnormally is received, the server state monitor step determines the server as working abnormally, and records information included in the server-abnormal notification in a log, with correspondence established with relay information.

Also preferably, in the medium according to the invention, if the server is determined as working abnormally, the server state monitor step further terminates relay to the server.

Also preferably, in the medium according to the invention, only while relaying, the relay step manages relay information concerning the relay, and if the server is determined as working abnormally, the server state monitor step deletes relay information corresponding to the server, thereby to terminate relay to the server.

Also preferably, in the medium according to the invention, the relay information includes an IP address and a port number of each of the client, the server and the server monitor device.

According to another aspect of the present invention, there is provided a server monitor device connected between a client and a server, comprising: a relay section that relays between the client and the server, and manages information concerning the relay as relay information; and a server state monitor section that determines whether the server works abnormally or not, based on communication between the server monitor device and the server, and records, in a log, information included in relay information corresponding to relay to the server if the server is determined as working abnormally.

According to further another aspect of the present invention, there is provided a server monitor method using a server monitor device connected between a client and a server, comprising: a relay step that relays between the client and the server, and manages information concerning the relay as relay information, in the server monitor device; and a server state monitor step that determines whether the server works abnormally or not, based on communication between the server monitor device and the server, and records, in a log, information included in relay information corresponding to relay to the server if the server is determined as working abnormally, in the server monitor device.

Preferably, in the server monitor method according to the invention, after the relay step, the server executes a server state notification step that determines whether the server works abnormally or not and transmits server-abnormal notification as a notification including information of abnormality if the server is determined as working abnormally, to the server monitor device.

Also preferably, in the server monitor method according to the invention, during normal operation, the server state notification step transmits a server-normal notification to the server monitor device at predetermined timing, the server-normal notification being a notification indicating that the server works normally, and the server state monitor step monitors the notification from the server state notification step, and determines the server as working abnormally if the server-normal notification cannot be received for a predetermined period.

Also preferably, in the server monitor method according to the invention, if the server-abnormal notification is received, the server state monitor step determines the server as working abnormally, and records, in a log, information of abnormality included in the server-abnormal notification.

Also preferably, in the server monitor method according to the invention, if the server is determined as working abnormally, the server state monitor step further terminates relay to the server.

Also preferably, in the server monitor method according to the invention, only while relaying, the relay step manages relay information concerning the relay, and if the server is determined as working abnormally, the server state monitor step deletes relay information corresponding to the server, thereby to terminate relay to the server.

Also preferably, in the server monitor method according to the invention, after the relay step, the server executes an unauthorized access monitor step that, if unauthorized access to the server is detected, outputs information of the detected unauthorized access as unauthorized access information, and the server state notification step obtains an output from the unauthorized access monitor step, and determines whether the server works abnormally or not, based on the output from the unauthorized access monitor step.

Also preferably, in the server monitor method according to the invention, during normal operation, the unauthorized access monitor step outputs normal information at predetermined timing, the normal information indicative of being normal, and if the normal information cannot be obtained from the unauthorized access monitor step, the server state notification step determines the server as working abnormally, and transmits a server-abnormal notification including information of the abnormality, to the server monitor device.

Also preferably, in the server monitor method according to the invention, if unauthorized access to the server is detected, the unauthorized access monitor step establishes correspondence between information of manipulation concerning the unauthorized access and information of communication, and takes a result thereof as unauthorized access information.

Also preferably, in the server monitor method according to the invention, if unauthorized access information is outputted by the unauthorized access monitor step, the server state notification step determines the server as working abnormally, and transmits a server-abnormal notification including the unauthorized access information to the server monitor device.

Also preferably, in the server monitor method described above, during normal operation, the server state notification step outputs, at predetermined timing, normal information indicative of being normal, and after the server state notification step, the server further executes a server state notification monitor step that obtains an output from the server state notification step, determines the server as working abnormally if the normal information from the server state notification step cannot be obtained for a predetermined period, and records information of the abnormality, in a log.

Also preferably, in the server monitor method described above, the relay information includes an IP address and a port number of each of the client, the server, and the server monitor device.

According to the present invention, an audit trail can be obtained even if an administrator authority leaks. Further, servers are less influenced by introduction of the invention.

### BRIEF DESCRIPTION OF THE DRAWINGS

FIG. 1 is a block diagram showing an example of configuration of an application system according to an embodiment of the present embodiment;

FIG. 2 is a table showing configuration of relay information in a relay information management table according to the embodiment;

FIG. 3 is a table showing an example of an entry in a relay log according to the embodiment;

FIG. 4 is a sequence chart showing an example of operation of the application system during normal operation, according to the embodiment;

FIG. 5 is a sequence chart showing an example of operation of monitoring a server state notify section 15 by a server state monitor section 34, according to the embodiment;

FIG. 6 is a sequence chart showing an example of operation of monitoring an unauthorized access monitor section 14 by the server state notify section 15, according to the embodiment;

FIG. 7 is a sequence chart showing an example of operation of monitoring the server state notify section 15 by the unauthorized access monitor section 14, according to the embodiment;

FIG. 8 is a sequence chart showing an example of operation in case where a server log 13 is altered by unauthorized access in the application system according to the embodiment;

FIG. 9 is a table showing an example of unauthorized access information notified by the server state notify section 15, according to the embodiment;

FIG. 10 is a sequence chart showing an example of operation in case where the unauthorized access monitor section 14 is stopped by unauthorized access, in the application system according to the embodiment; and

FIG. 11 is a sequence chart showing an example of operation in case where the server state notify section 15 is stopped by unauthorized access, in the application system according to the embodiment.

### DETAILED DESCRIPTION OF THE PREFERRED EMBODIMENTS

An embodiment of the present invention will now be described with reference to the drawings.

Configuration of an application system according to the present embodiment will be described first.

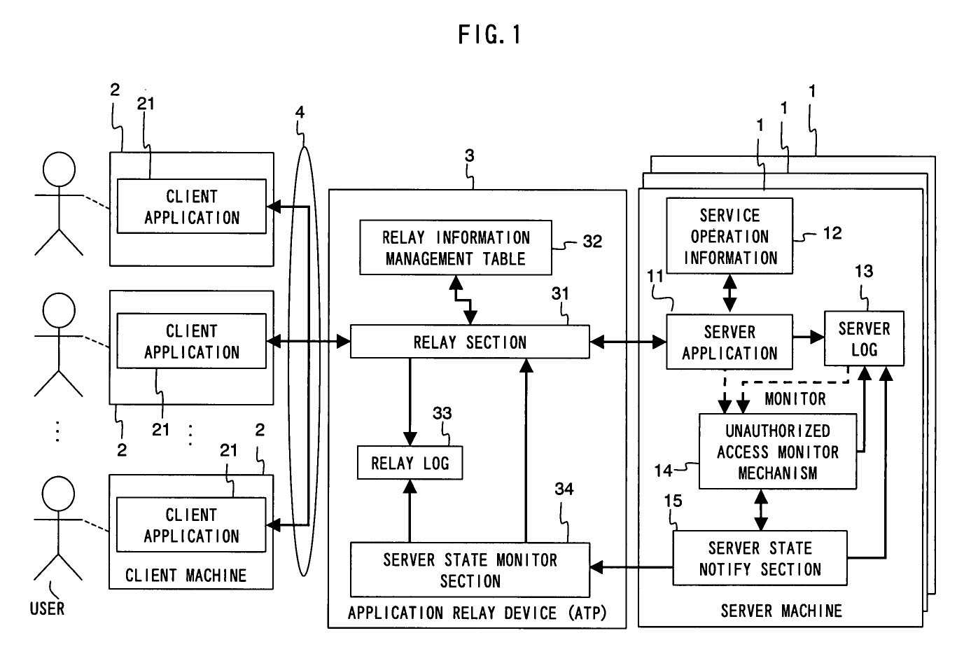

FIG. 1 is a block diagram showing an example of configuration of an application system according to the present embodiment. This is an audit trail system including plural server machines 1, plural client machines 2, an application relay device (or an Audit Trail Proxy: ATP) 3, and a network 4. In each of the server machine 1, a server application to provide users with services works. The application relay device 3 is a server monitor device according to the present invention, and works to relay between the plural server machines 1 and the client machines 2. The network 4 connects the client machines 2 and the ATP 3.

The ATP 3 includes a relay section 31, a relay information management table 32, a relay log 33, and a server state monitor section 34. Next, these respective sections of the ATP 3 will be described.

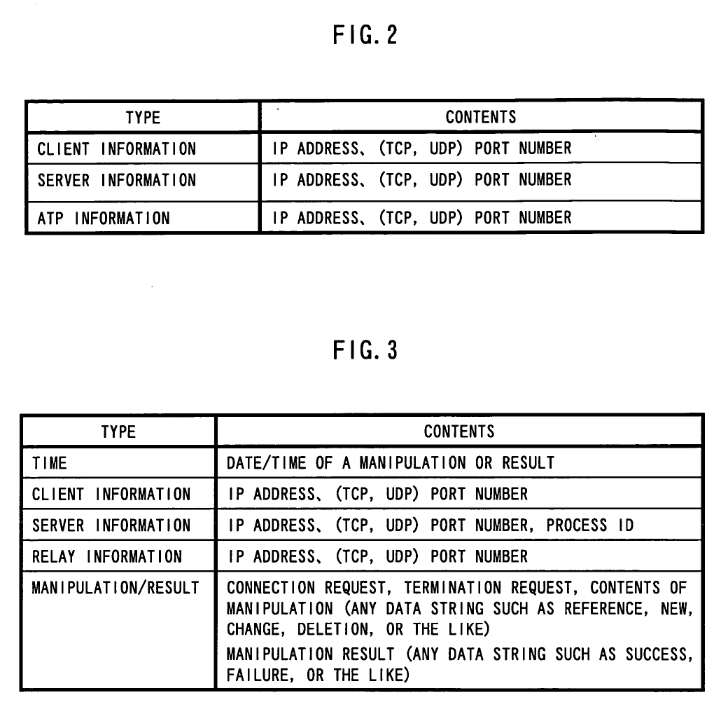

The relay section 31 refers to the relay information management table 32, and relays communication between the client machines 2 and the plural server machines 1. The relay section 31 also records manipulations and results in a relay log 33. FIG. 2 is a table showing an example of configuration of relay information in the relay information management table. As shown in this table, the relay information management table includes, as relay information necessary for relaying, client information, server information, and ATP information. The client information includes an IP address and a port number of a client machine 2 as an access source. The server information includes an IP address and a port number of a server machine 1 as a access destination. The ATP information includes a local IP address and a port number of the ATP 2. This set of relay information is prepared for every relaying session, and is deleted after the relying session is completed. FIG. 3 is a table showing an example of configuration of an entry of a relay log according to the present embodiment. As shown in FIG. 3, the relay log 33 includes time information and manipulation/result information in addition to the client information, server information, and ATP information as described above. This set of information is recorded as an entry for every manipulation or result. The server state monitor section 34 receives information transmitted from a server state notify section 15 in a server machine 1. If an unauthorized access exists, the server state monitor section 34 issues a relay termination instruction to the relay section 31, instructing the relay section 31 to terminate relaying of the access.

The server machine 1 includes a server application 11, server operation information 12, a server log 13, an unauthorized access monitor section 14, and a server state notify section 15. Next, these respective sections of the server machine 1 will be described.

The server application 11 is an application which provides users with services, as in conventional technology. For example, the application 11 utilizes HTTP (HyperText Transfer Protocol), FTP (File Transfer Protocol), TELNET, SSH (Secure SHell), or the like. The server operation information 12 is information used by the server application 11, as in conventional technology, e.g., personal information of which leakage and alteration are not allowed. The server log 13 records states of use by the server application 11, as in the conventional technology. The unauthorized access monitor section 14 works as a mechanism to monitor unauthorized access at the application level, prevent unauthorized access, and obtain an audit trail, as in the first conventional technology for obtaining audit trails. The unauthorized access monitor section 14 also monitors the server state notify section 15. The server state notify section 15 monitors the unauthorized access monitor section 14 and notifies the server state monitor section 34 in the ATP 3 of a result of monitoring unauthorized access by the unauthorized access monitor section 14.

The client machine 2 has a client application 21 to use the server application 11. The client application 21 accesses a server machine 1 through the relay section 31, operates the server application 11, and receives a result therefrom.

The network 4 may be the Internet, a dosed network, or a LAN.

Next, normal operation of the application system according to the present embodiment will be described.

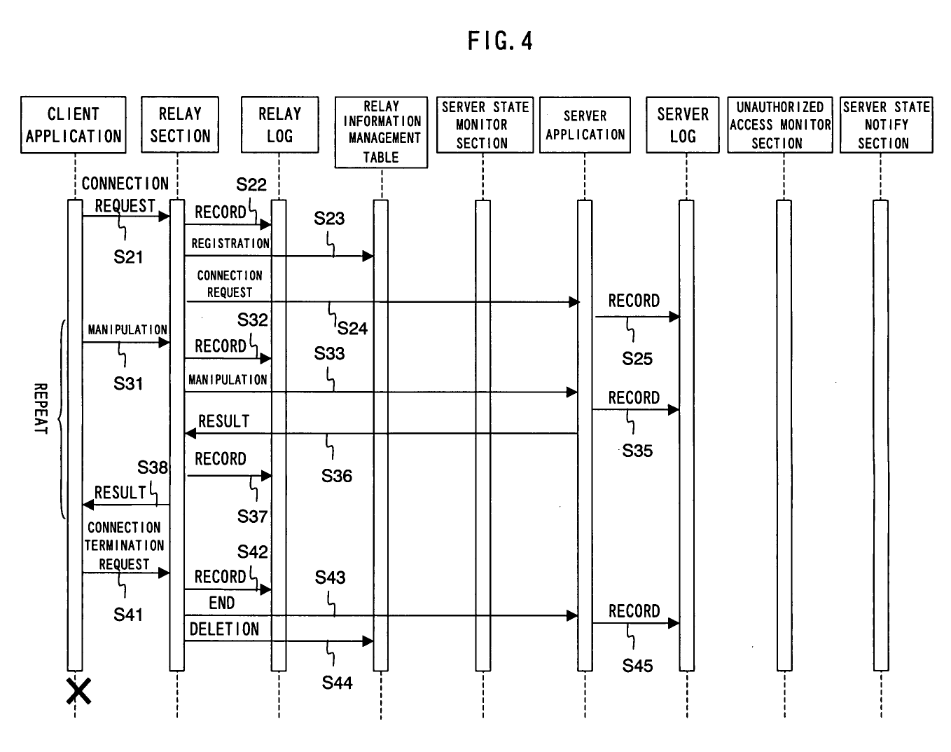

FIG. 4 is a sequence chart showing normal operation of the application system according to the present embodiment. In this sequence chart, time flow is expressed as a flow from upside to downside. Vertical lanes respectively express operations of the client application 21, relay section 31, relay information management table 32, relay log 33, server state monitor section 34, server application 11, server log 13, unauthorized access monitor section 14, and server state notify section 15, in this order from the left side of the sequence chart.

Firstly, the client application 21 firstly requests a connection to the server application 11 (S21). The relay section 31 records this connection request in a relay log 33 (S22), and registers relay information in the relay information management table 32 (S23). The relay section 31 transfers this connection request to the server application 11 (S24). The server application 11 which has received the connection request starts the connection, and records the contents of the operation in the server log 13 (S25).

When the client application 21 makes a manipulation on the server application 11 (S31), the relay section 31 records this manipulation in a relay log 33 (S32) and transfers the log to the server application 11 (S34). The server application 11 which has received the manipulation executes the manipulation. The server application 11 records the contents of operation in a server log 13 (S35) and replies to the relay section 31 with a manipulation result thereof (S36). The relay section 31 which has received the manipulation result records the manipulation result in a relay log 33 (S37), and transfers the manipulation result to the client application 21 (S38). These processings S31 to S38 are repeated at every manipulation thereafter.

When the client application 21 requests termination of the connection (S41), the relay section 31 records the connection termination request in a relay log 33 (S42), and transfers the connection termination request to the server application 11 (S43). The relay section 31 deletes relay information from the relay information management table 32 (S44). The server application 11 which has received the connection termination request terminates the connection, and records the contents of operation in a server log 13 (S45). Then, this sequence ends.

A next description will be made of operation of monitoring the server state notify section 15 by the server state monitor section 34.

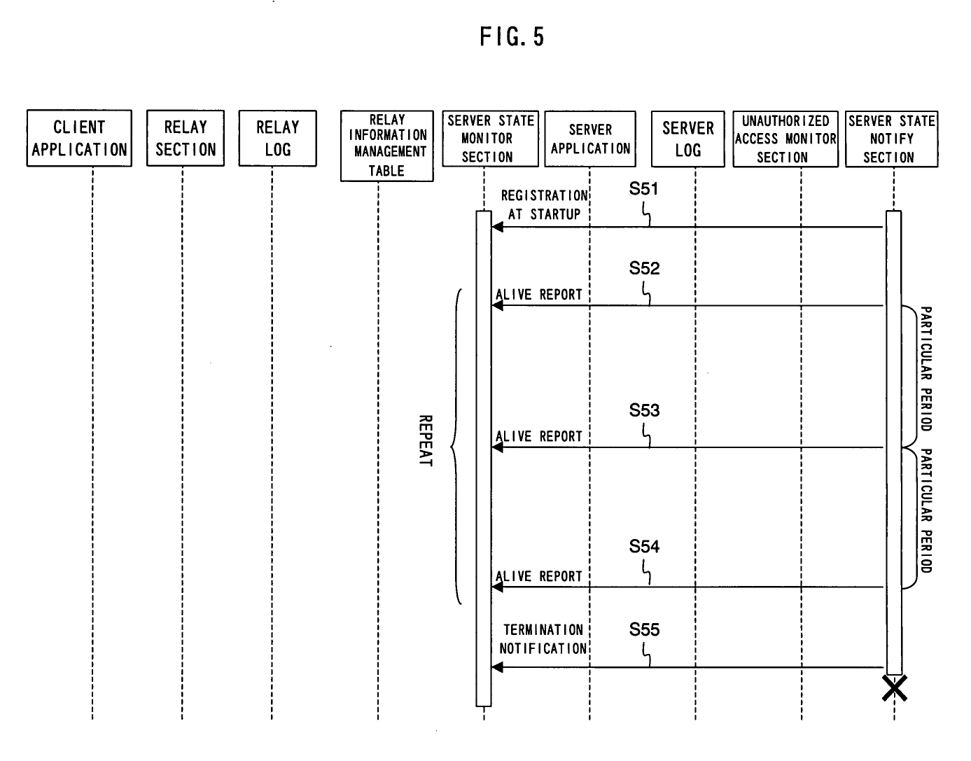

FIG. 5 is a sequence chart showing an example of the monitor operation of monitoring the server state notify section 15 by the server state monitor section 34 according to the embodiment. Firstly, the server state notify section 15 starts up, and establishes and registers a TCP (Transmission Control Protocol) session with respect to the server state monitor section 34 (S51). Next, the server state notify section 15 periodically notifies the server state monitor section 34 of an alive report indicating that the section 15 itself works successfully (S52, S53, and S54). When the server state notify section 15 is terminated successfully, the successful termination is notified to the server state monitor section 34 (S55), and the TCP session is terminated. If the TCP session is shut down during the TCP session or if no alive report is given over a particular period from the server state notify section 15, the server state monitor section 34 determines that the server state notify section 15 stops.

Next, operation of monitoring the unauthorized access monitor section 14 by the server state notify section 15 will be described.

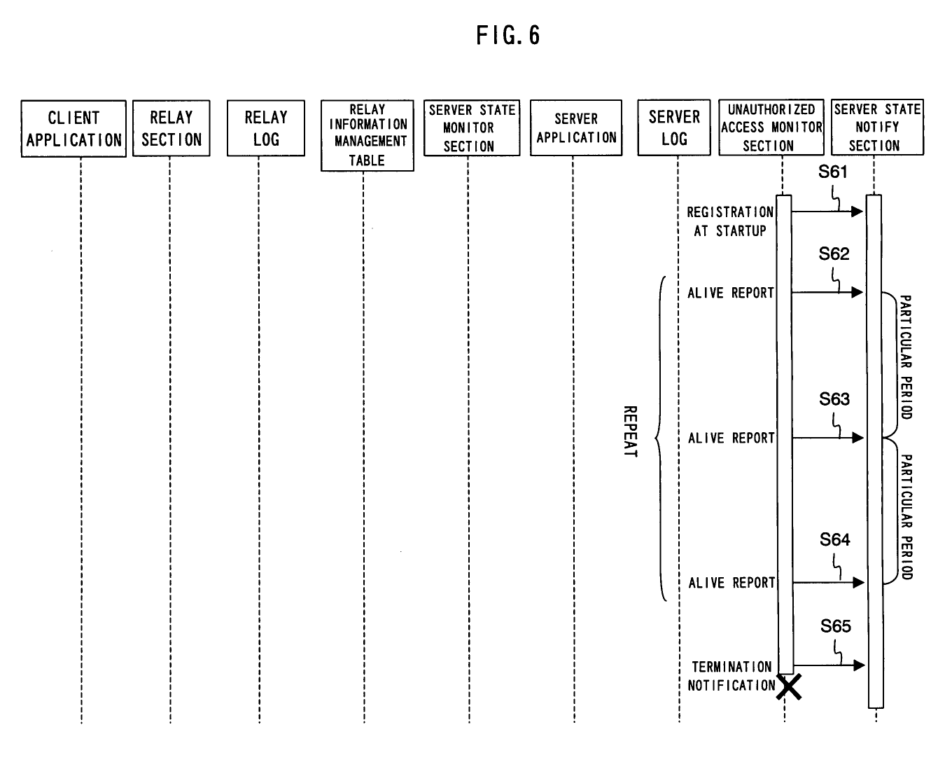

FIG. 6 is a sequence chart showing an example of the operation of monitoring the unauthorized access monitor section 14 by the server state notify section 15 according to the present embodiment. Like monitoring of the server state notify section 15 by the server state monitor section 34, the unauthorized access monitor section 14 is registered in the server state notify section 15 (S61), and starts a TCP session. The unauthorized access monitor section 14 periodically notifies the server state notify section 15 of an alive report (S62, S63, and S64) until the TCP session is completed successfully (S63). If the TCP session is shut down during the TCP session with the unauthorized access monitor section 14 or if no alive report is given from the unauthorized access monitor section 14 over a particular period, the server state notify section 15 determines that the unauthorized access monitor section 14 has stopped.

Next, operation of monitoring the server state notify section 15 by the unauthorized access monitor section 14 will be described.

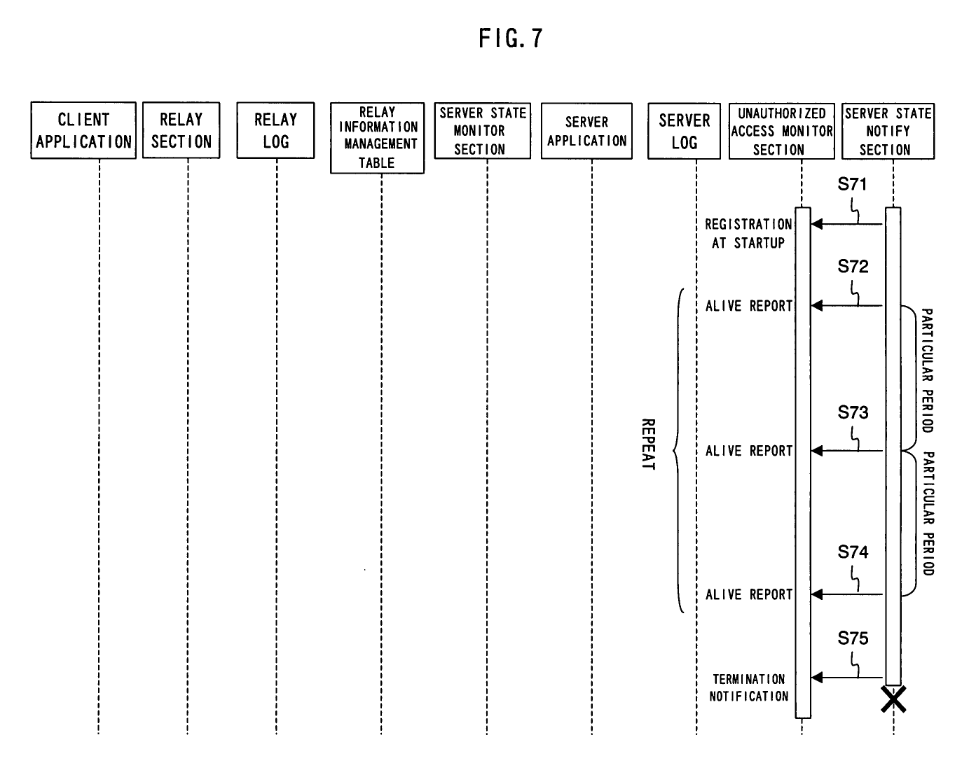

FIG. 7 is a sequence chart showing an example of the operation of monitoring the server state notify section 15 by the unauthorized access monitor section 14 according to the present embodiment. Like monitoring of the server state notify section 15 by the server state monitor section 34, the server state notify section 15 is registered in the unauthorized access monitor section 14 (S71), and starts a TCP session. The server state notify section 15 periodically notifies the unauthorized access monitor section 14 of an alive report (S72, S73, and S74) until the TCP session is completed successfully (S73). If the TCP session is shut down during the TCP session with the server state notify section 15 or if no alive report is given from the server state notify section 15 over a particular period, the unauthorized access monitor section 14 determines that the server state notify section 15 has stopped. However, the configuration may be arranged such that the unauthorized access monitor section 14 does not perform the monitoring of the server state notify section 15.

The alive reports in FIGS. 5 to 7 may be encrypted with use of a one-time password to prevent spoofing.

Next, three cases will be described with respect to operation of unauthorized access in the application system according to the present embodiment.

Described first will be operation in the first case in which a server log 13 is altered (for example, deleted) by unauthorized access from a client application 21.

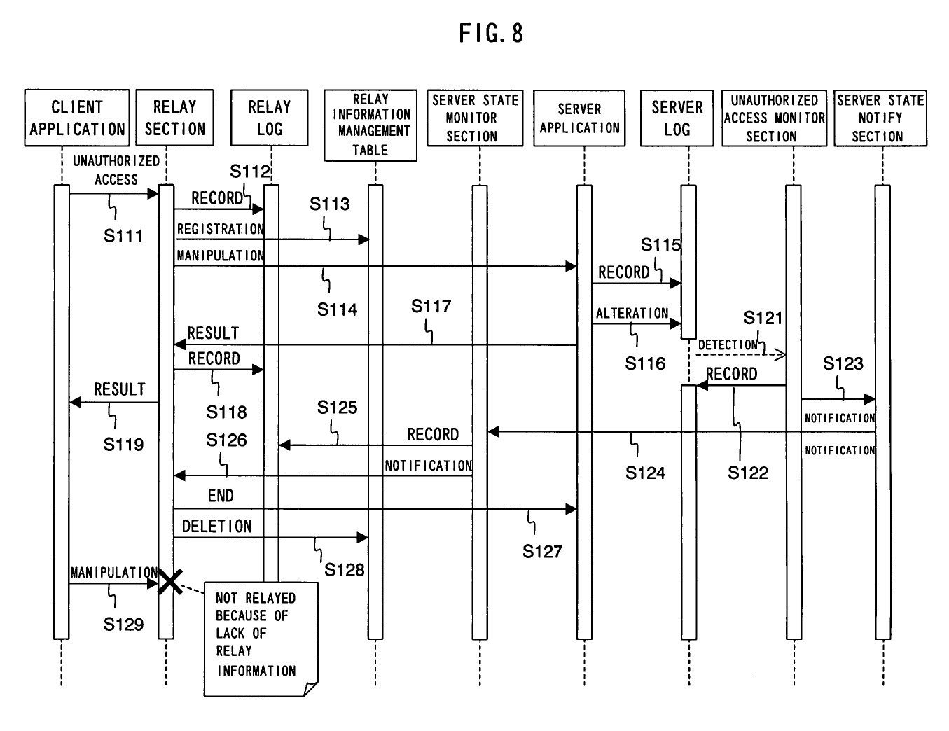

FIG. 8 is a sequence chart showing an example of operation in case where a server log 13 is altered by unauthorized access in the application system according to the present embodiment. When a client application 21 conducts manipulation by unauthorized access (S111), this manipulation is recorded in a relay log 33 (S112). The relay information is registered in the relay information management table 32 (S113). This manipulation is transferred to a server application 11 (S114). The server application 11 which has received the manipulation records this manipulation in the server log 13 (S115). The server application 11 executes this manipulation thereby to delete the server log 13 (S116).

Next, the server application 11 replies to the relay section 31 with a result of the manipulation, like in normal operation (S117). The relay section 31 which has received the manipulation result records the manipulation result in the relay log (S118), and transfers the manipulation result to the server application 11 (S119).

On the other side, the unauthorized access monitor section 14 monitors reading, alteration, creation, deletion, name change, attribute change, and the like of the server log 13. The unauthorized access monitor section 14 detects a manipulation made on the server log 13 (for example, by use of a technique of “dnotify”). If a manipulation made on the server log 13 is detected, the unauthorized access monitor section 14 obtains a process ID with which the detected manipulation was conducted (for example, by use of a technique of “Isof”). The unauthorized access monitor section 14 further traces back a parent of the obtained process ID (for example, by use of a technique of “proc” file system), and obtains a hierarchical process ID list. Also, the unauthorized access monitor section 14 checks one after another of IP addresses and TCP/UDP port numbers of access sources of communications being connected respectively under the obtained process IDs (for example, by use of a technique of “netstat”). This check continues until a communication with the ATP 3 is found. In this manner, the unauthorized access monitor section 14 obtains information concerning communication which based the above-mentioned manipulation, thereby to establish correspondence between the manipulation concerning the unauthorized access and the communication, which is taken as one piece of unauthorized access information.

If the unauthorized access monitor section 14 detects deletion of the server log 13 (S121), the unauthorized access monitor section 14 records the unauthorized access information in the server log 13 (S122), and notifies the server state notify section 15 of the unauthorized access information (S123). In this case, the information concerning the unauthorized access is recorded in the same server log 13 as the deleted server log 13. Alternatively, this unauthorized access information may be recorded into another server log.

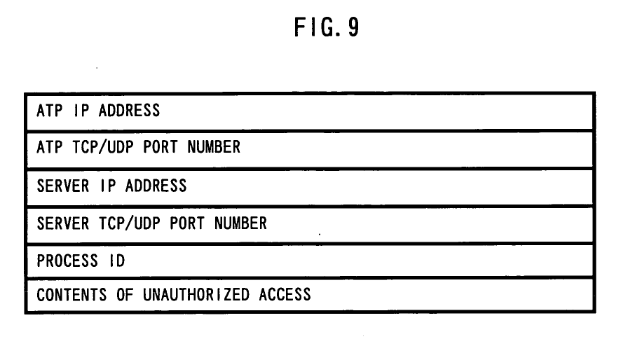

The server state notify section 15 which has received the unauthorized access information further notifies the server state monitor section 34 of the unauthorized access information (S124). FIG. 9 is a table showing an example of unauthorized access information notified by the server state notify section 15 according to the present embodiment. The unauthorized access information which the server state notify section 15 notifies to the server state monitor section 34 includes an IP address of the ATP 3, a TCP/UDP port number thereof, an IP address of the server application 11, a TCP/UDP port number thereof, a process ID, and the contents of an unauthorized access manipulation. As has been described previously, the unauthorized access monitor section 14 establishes correspondence between manipulation and communication concerning unauthorized access. In place of the unauthorized access monitor section 14, the server state notify section 15 may establish such correspondence.

The server state monitor section 34 which has received the unauthorized access information records the unauthorized access information in the relay log 33 (S125). The server state monitor section 34 now checks whether or not the TCP/UDP port number of the access source in the information notified by the server state notify section 15 exists in ATP information in the relay information management table 32. If the TCP/UDP port number exists, the relay thereof is considered as having relayed the unauthorized access, and a corresponding client application 21 is considered as having conducted unauthorized access. At this time, the server state monitor section 34 obtains client information, server information, and relay information which correspond to the unauthorized access, from the relay information management table 32. The server state monitor section 34 also obtains a process ID and contents of an unauthorized access manipulation, from the unauthorized access information notified by the server state notify section 15, and further obtains time. The server state monitor section 34 then records a set of these pieces of information in the relay log 33. Next, server state monitor section 34 notifies the relay section 31 of a relay termination instruction to instruct the relay section 31 to terminate corresponding relay (S126).

The relay section 31 which has received the relay termination instruction notifies the termination of the relay to the server application 11 (S127), and deletes corresponding relay information from the relay information management table 32 (S128). This sequence then ends. Even if the client application 21 thereafter tries to send any manipulation to the server application 11 (S129), relay is rejected because no relay information exists in the relay information management table 32. Thus, if a server log 13 is altered (deleted), this unauthorized access is recorded in another new server log 13 or a relay log 33, and this record works as a trail.

The server state monitor section 34 which has received unauthorized access information may pass relay information in the relay information management table 32 to the server state notify section 15. As the server state notify section 15 or unauthorized access monitor section 14 seeks communication corresponding to unauthorized access, correspondence between a manipulation and communication concerning unauthorized access can be established rapidly.

If a server log 13 is altered in case of using the first conventional technology for obtaining audit trails, there is no trail remaining. According to operation in the first case described above, however, the unauthorized access monitor section 14 detects unauthorized access to a server log 13, and records the unauthorized access in the server log 13 or a relay log 33. Thus, a trail of the unauthorized access can be securely kept remaining. Besides, further unauthorized access can be prevented by terminating relay through the relay section 31.

Described next will be operation in the second case in which the unauthorized access monitor section 14 is stopped by unauthorized access from a client application 21.

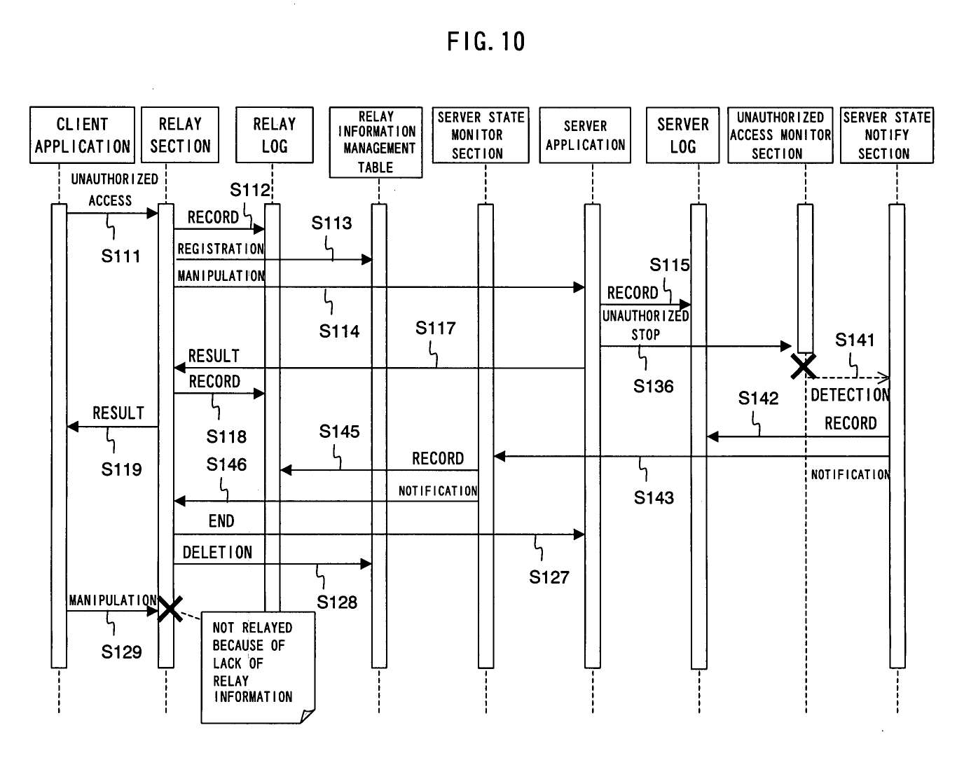

FIG. 10 is a sequence chart showing an example of operation in case where the unauthorized access monitor section 14 is stopped irregularly by unauthorized access in the application system according to the present embodiment. In FIG. 10, the same reference symbols as those in FIG. 8 respectively denote the same components as shown in FIG. 8 or equivalent processings to those in FIG. 8. Descriptions thereof will be omitted herefrom. The manipulation which the server application 11 has received in step S114 is executed, and the unauthorized access monitor section 14 is thereby stopped irregularly (S136). Next, the same processings S117 to S119 as those in the first case are carried out with respect to the result of the manipulation.

As has been described above, the unauthorized access monitor section 14 periodically issues an alive report to the server state notify section 15 during normal operation. This alive report is stopped when the unauthorized access monitor section 14 stops. If no alive report is received from the unauthorized access monitor section 14, the server state notify section 15 detects the stop of the unauthorized access monitor section 14 (S141), and records the contents thereof in a server log 13 (S142). The server state notify section 15 notifies the server state monitor section 34 of information concerning unauthorized access as unauthorized access information (S143). Although information concerning unauthorized access is recorded in the server log 13 in this case, the information concerning unauthorized access may be recorded in another server log.

Next, the server state monitor section 34 records information concerning the stop of the unauthorized access monitor section 14 in a relay log 33 (S145). The server state monitor section 34 further notifies the relay section 31 of a relay termination instruction to instruct the relay section 31 to terminate all relays to the IP address of the server machine 1 in which the server state notify section 15 as a monitor target is working (S146). Thereafter, the same processings S127 and S128 as those in the first case are carried out.

If the unauthorized access monitor section 14 detects unauthorized access like in the first case, the unauthorized access monitor section 14 establishes correspondence between the unauthorized access and a process ID, as has been described previously. However, if the unauthorized access monitor section 14 stops as described in the second case, unauthorized access information notified to the server state monitor section 34 from the server state notify section 15 includes only the contents of the unauthorized access but does not include information indicative of which relay corresponds to the unauthorized access.

After the unauthorized access monitor section 14 is stopped, nothing is recorded in the server log 13 even if unauthorized access is thereafter made against the server machine 1. In this state, if further unauthorized access is made and if the manipulation thereof is encrypted or concealed so as not to be distinguished from usual manipulations, the unauthorized access is very difficult to find out for the relay section 31.

However, according to the operation described above in the second case, the server state notify section 15 detects the stop of the unauthorized access monitor section 14, and records the stop in the server log 13 or relay log 33. In this manner, a trail of the unauthorized access can be securely kept remaining. In addition, further unauthorized access in a state in which the unauthorized access monitor section 14 is not working can be prevented by terminating relays performed by the relay section 31.

Described next will be operation in the third case in which the server state notify section 15 is stopped by unauthorized access from a client application 21.

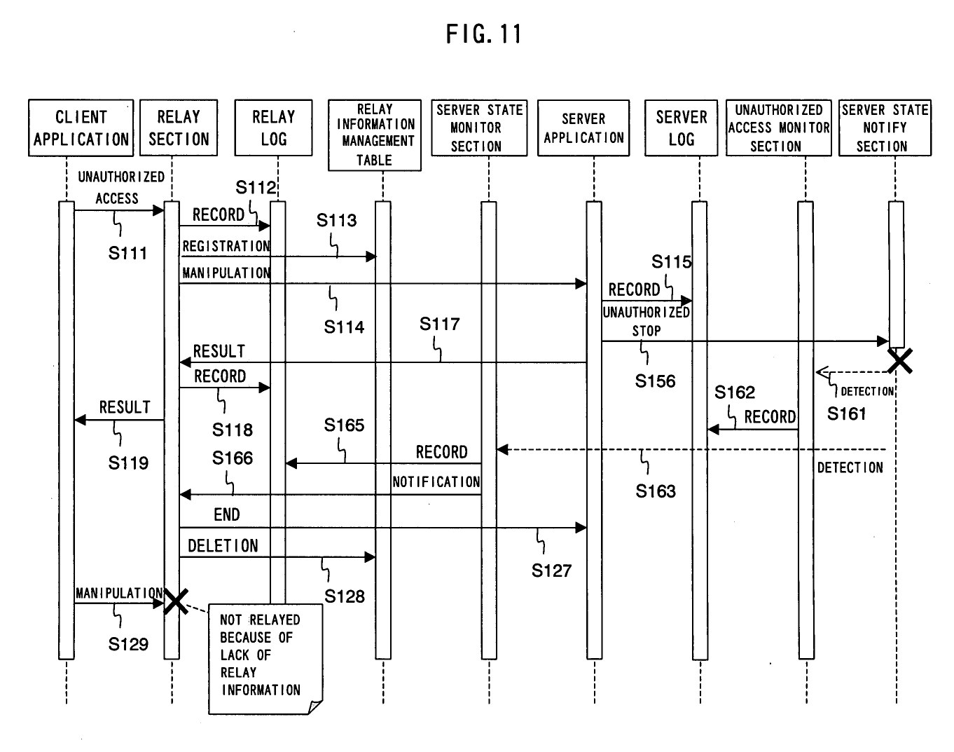

FIG. 11 is a sequence chart showing an example of operation in case where the server state notify section 15 is stopped by unauthorized access in the application system according to the present embodiment. In FIG. 11, the same reference symbols as those in FIG. 8 respectively denote the same components as those in FIG. 8 or equivalent processings to those in FIG. 8. Descriptions thereof will be omitted here. The manipulation which the server application 11 has received in step S64 is executed, and the server state notify section 15 is thereby stopped (S156). Next, the same processings S117 to S119 as those in the first case are carried out with respect to the result of the manipulation.

As has been described above, the server state notify section 15 periodically issues an alive report to the unauthorized access monitor section 14 during normal operation. This alive report is stopped when the server state notify section 15 stops. If no alive report is received from the server state notify section 15, the unauthorized access monitor section 14 detects the stop of the server state notify section 15 (S161), and records the contents thereof in a server log 13 (S162). Although information concerning unauthorized access is recorded in the server log 13 in this case, the information concerning unauthorized access may be recorded in another server log.

Further, as has been described above, the server state notify section 15 periodically issues an alive report to the server state monitor section 34 during normal operation. This alive report is stopped when the server state notify section 15 stops. If no alive report is received from the server state notify section 15, the server state monitor section 34 detects the stop of the server state notify section 15 (S163).

Next, the server state monitor section 34 records information concerning the stop of the server state notify section 15 in a relay log 33 (S165). The server state monitor section 34 further notifies the relay section 31 of a relay termination instruction to instruct the relay section 31 to terminate all relays to the IP address of the server machine 1 in which the server state notify section 15 as a monitor target is working (S166). Thereafter, the same processings S127 to S128 as those in the first case are carried out.

After the server state notify section 15 is stopped, no unauthorized access can be detected even if unauthorized access is thereafter made against the unauthorized access monitor section 14. In this state, if further unauthorized access is made and if the manipulation thereof is encrypted or concealed so as not to be distinguished from usual manipulations, the unauthorized access is very difficult to find out for the relay section 31.

However, according to the operation described above in the third case, the unauthorized access monitor section 14 or the server state monitor section 34 detects the stop of the server state notify section 15, and records the stop in the server log 13 or relay log 33. In this manner, a trail of the unauthorized access can be securely kept remaining. In addition, further unauthorized access in a state in which the server state notify section 15 is not working can be prevented by terminating relays performed by the relay section 31.

Alternatively, even in case where unauthorized access is made simultaneously to a plurality or all of the server log 13, unauthorized access monitor section 14, and server state notify section 15, relays are terminated upon the stop of the server state notify section 15, so that further unauthorized access can be prevented.

In addition, the ATP 3 may be configured to include an access permission table which registers in advance the IP addresses of client machines 2 and the types of users of the client machines 2. The relay section 31 may determine either permission to or prohibition against relays from client applications 21 by referring to the access permission table.

Alternatively, the ATP 3 may be provided with a manipulation permission/prohibition table which registers in advance conditions concerning manipulations and results which are prohibited from being relayed. The relay section 31 may reject relay of those manipulations and results that match the conditions by referring to the manipulation permission/prohibition table. For example, if an file name an access of which is prohibited is included in a manipulation, the relay section 31 rejects relay of the manipulation. Alternatively, for example, if a personal information data sequence is included in a result, the relay section 31 rejects relay of the result.

Further, the relay log 33 and the server log 13 may be collected in the ATP 3 or exist in a different machine from the ATP 3 and the server machines 1. To distribute load from client applications 21, a plurality of ATPs 3 may be installed.

In the present embodiment, the server state notify section 15 notifies the server state monitor section 34 of unauthorized access information detected by the unauthorized access monitor section 14 and abnormality of the unauthorized access monitor section 14. However, without using the unauthorized access monitor section 14, the server state notify section 15 may be configured to detect abnormality of the server machine 1, record the abnormality in a server log 13, and simultaneously notify the server state monitor section 34 of the abnormality.

As has been specifically described above, according to the present invention, the ATP 3 outside the server machine 1 monitors operation of the unauthorized access monitor section 14. If the unauthorized access monitor section 14 stops or an alteration is made, the ATP 3 shuts down relays so that alterations to a server log and leakages of service operation information can be prevented. The server machine 1 uses the same functions as those of a conventional unauthorized access monitor section at the application level. Influences on the server are weaker and introduction costs are greatly reduced, compared with another conventional unauthorized access monitor section at the kernel level. Unlike the conventional unauthorized access monitor section at the application level, an audit trail can be obtained even if an administrator authority of the server machine 1 leaks.

The server monitor device according to the present embodiment is easily applicable to a relay device and can improve performance of the relay device. The relay device mentioned here may include, for example, a proxy server, bridge, switch, router, and the like.

Further, a program to let a computer constituting the server monitor device execute the respective processing steps described above can be provided in form of a relay program. This program may be stored in a recording medium readable from a computer. Then, the computer constituting the server monitor device can be let execute the program. Such recording media readable from a computer may include an internal storage device built in a computer such as a ROM or RAM, a portable recording medium such as a CD-ROM, flexible disk, DVD disk, magneto-optical disk, or IC card, a database to maintain computer programs, another computer with a database thereof, and further on-line transfer media.

The server monitor device corresponds to the ATP in the embodiment. Servers correspond to the server machines in the embodiment. Clients correspond to the client machines in the embodiment A relay step and a relay section correspond to the relay section and the relay information table in the embodiment. A server state monitor step and a server state monitor section correspond to the server state monitor section and the relay log in the embodiment. A server state notify step corresponds to the server state notify section in the embodiment. An unauthorized access monitor step and a server state notify monitor step correspond to the unauthorized access monitor section in the embodiment A server-normal notification and normal information correspond to the alive report in the embodiment.

What is claimed is:

1. A computer-readable recording medium having a server monitor program recorded thereon, said program adapted to execute on a computer of a server monitor device connected between a client and a server, the program comprising:
a relay step that relays between the client and the server, and manages information concerning the relay as relay information; and
a server state monitor step that determines whether the server works abnormally or not, based on communication between the server monitor device and the server, and records, in a log, information included in relay information corresponding to relay to the server if the server is determined as working abnormally.

2. The medium according to claim 1, wherein if a server-normal notification as a notification given when the server works normally cannot be received, the server state monitor step determines the server as working abnormally.

3. The medium according to claim 2, wherein
the server-normal notification is transmitted to the server monitor device from the server at predetermined timing, and
if the server monitor device cannot receive the server-normal notification for a predetermined period, the server state monitor step determines the server as working abnormally.

4. The medium according to claim 1, wherein if a server-abnormal notification indicating that the server is working abnormally is received, the server state monitor step determines the server as working abnormally, and records information included in the server-abnormal notification in a log, with correspondence established with relay information.

5. The medium according to claim 1, wherein if the server is determined as working abnormally, the server state monitor step further terminates relay to the server.

6. The medium according to claim 5, wherein
only while relaying, the relay step manages relay information concerning the relay, and
if the server is determined as working abnormally, the server state monitor step deletes relay information corresponding to the server, thereby to terminate relay to the server.

7. The medium according to claim 1, wherein the relay information includes an IP address and a port number of each of the client, the server and the server monitor device.

8. A server monitor device connected between a client and a server, comprising:
a relay section that relays between the client and the server, and manages information concerning the relay as relay information; and
a server state monitor section that determines whether the server works abnormally or not, based on communication between the server monitor device and the server, and records, in a log, information included in relay information corresponding to relay to the server if the server is determined as working abnormally.

9. A server monitor method using a server monitor device connected between a client and a server, comprising:
a relay step that relays between the client and the server, and manages information concerning the relay as relay information, in the server monitor device; and
a server state monitor step that determines whether the server works abnormally or not, based on communication between the server monitor device and the server, and records, in a log, information included in relay information corresponding to relay to the server if the server is determined as working abnormally, in the server monitor device.

10. The server monitor method according to claim 9, wherein after the relay step, the server executes a server state notification step that determines whether the server works abnormally or not and transmits server-abnormal notification as a notification including information of abnormality if the server is determined as working abnormally, to the server monitor device.

11. The server monitor method according to claim 10, wherein
during normal operation, the server state notification step transmits a server-normal notification to the server monitor device at predetermined timing, the server-normal notification being a notification indicating that the server works normally, and
the server state monitor step monitors the notification from the server state notification step, and determines the server as working abnormally if the server-normal notification cannot be received for a predetermined period.

12. The server monitor method according to claim 10, wherein if the server-abnormal notification is received, the server state monitor step determines the server as working abnormally, and records, in a log, information of abnormality included in the server-abnormal notification.

13. The server monitor method according to claim 9, wherein if the server is determined as working abnormally, the server state monitor step further terminates relay to the server.

14. The server monitor method according to claim 13, wherein
only while relaying, the relay step manages relay information concerning the relay, and
if the server is determined as working abnormally, the server state monitor step deletes relay information corresponding to the server, thereby to terminate relay to the server.

15. The server monitor method according to claim 10, wherein
after the relay step, the server executes an unauthorized access monitor step that, if unauthorized access to the server is detected, outputs information of the detected unauthorized access as unauthorized access information, and
the server state notification step obtains an output from the unauthorized access monitor step, and determines whether the server works abnormally or not, based on the output from the unauthorized access monitor step.

16. The server monitor method according to claim 15, wherein
during normal operation, the unauthorized access monitor step outputs normal information at predetermined timing, the normal information indicative of being normal, and
if the normal information cannot be obtained from the unauthorized access monitor step, the server state notification step determines the server as working abnormally, and transmits a server-abnormal notification including information of the abnormality, to the server monitor device.

17. The server monitor method according to claim 15, wherein if unauthorized access to the server is detected, the unauthorized access monitor step establishes correspondence between information of manipulation concerning the unauthorized access and information of communication, and takes a result thereof as unauthorized access information.

18. The server monitor method according to claim 15, wherein if unauthorized access information is outputted by the unauthorized access monitor step, the server state notification step determines the server as working abnormally, and transmits a server-abnormal notification including the unauthorized access information to the server monitor device.

19. The server monitor method according to claim 10, wherein
during normal operation, the server state notification step outputs, at predetermined timing, normal information indicative of being normal, and
after the server state notification step, the server further executes a server state notification monitor step that obtains an output from the server state notification step, determines the server as working abnormally if the normal information from the server state notification step cannot be obtained for a predetermined period, and records information of the abnormality, in a log.

20. The server monitor method according to claim 9, wherein the relay information includes an IP address and a port number of each of the client, the server, and the server monitor device.
